(19) United States
(12) Patent Application Publication
(10) Pub. No.: US 2010/0009077 A1
(43) Pub. Date: Jan. 14, 2010

(54) Method for Treating a Material Having Nanoscale Pores

(76) Inventors: Franz Laermer, Weil Der Stadt (DE); Michael Stumber, Korntal-Muenchingen (DE); Ralf Reichenbach, Esslingen (DE); Dick Scholten, Stuttgart (DE); Christian Maeurer, Muchen (DE)

Correspondence Address: KENYON & KENYON LLP, ONE BROADWAY, NEW YORK, NY, 10004, US

(21) Appl. No.: 12/225,504

(22) PCT Filed: Feb. 12, 2007
(86) PCT No.: PCT/EP2007/051308

§ 371 Date: Aug. 14, 2009

(30) Foreign Application Priority Data
Apr. 3, 2006 (DE) 10 2006 015 382.0

(51) Int. Cl. B05D 7/22; B05C 9/08

(52) U.S. Cl. 427/230; 118/58

(57) ABSTRACT

A method and a device for treating a material having nanoscale pores), especially implant material for the treatment of living cells, as provided. The method distinguished in that the surface tension of a substance (10) provided for filling the volumes of the nanoscale pores (9) is reduced. The present invention also includes a device for carrying out this method.

### BACKGROUND OF THE INVENTION

1. Field of the Invention

The present invention relates to a method and a device for treating a material having nanoscale pores.

2. Description of Related Art

The use of carrier materials is known for the treatment and observation of, research on, or even the culturing of living cells, and they may be equipped with the most varied means. In particular, it is known in this connection that one may deposit active substances in nanoscale pores of a biocompatible material. Porosified silicon, for example, is appropriately suitable for this.

To prepare the porous silicon, hydrofluoric acid (HF) is used, for example, which is highly toxic. In an appropriate anodization method, the acid attacks the silicon in such a way that pores are created on the surface of the silicon whose size and structure are able to be determined by the varying of different anodization parameters. For the release of active substances from such a substrate that is locally as uniform as possible and able to be dispensed as accurately as possible, the development of extremely small structured pores is desirable whose geometries are in the nanometer range.

Because of capillary action, remainders of the highly toxic hydrofluoric acid stays on the inside of these nanoscale pores. Removing these hydrofluoric acid residues and possibly additional residues originating in the anodization mud is made possible only by complete contact of an appropriately suitable solvent. Up to now, however, using common solvents such as water, organic solvents, etc., this could not be reliably ensured, because these solvents are not well able to penetrate into the pores.

### A BRIEF SUMMARY OF THE INVENTION

An object of the present invention is improving the possibility of treatment of nanoscale pores, especially their surfaces.

The present invention accordingly relates to a method for treating material having nanoscale pores, especially implant material for the treatment of living cells. It is distinguished in that the surface tension of the substance or mixture of substances provided for filling the volume of the nanoscale pores is reduced.

Using this method of the present invention, penetrating even the smallest pores is possible even for such fluids that are able, only poorly or not at all, to penetrate into these regions under the usual method conditions. It is provided that one may convert the substances and mixtures of substances provided for this into a supercritical state, for penetrating into the nanoscale pores. This state has the effect that the substance used, or the mixture of substances used, assumes properties which lie between those that liquids and gases have. In particular, in this connection, its surface tension is able to be reduced by orders of magnitude, and in certain substances it may even be almost reduced to nothing, so that this substance is able to penetrate into the smallest structures of a surface depression.

CO₂ is preferably provided for use as a substance that is to be converted to a supercritical state. CO₂ has the advantage that it is not toxic during contact with living cells. Consequently, even the residues remaining after the treatment process of the nanoscale pores, and possibly thereafter, are thereby unable to produce any disadvantageous effects for the further application purpose of the substrate cleaned in this way, especially in response to contact with living cells.

An additional advantage of CO₂ is that it is a solvent for hydrofluoric acid (HF), so that, based on its complete penetration into the smallest porous recesses, it is able to dissolve hydrofluoric acid adhering to the inside of them, remove it from the surface and completely discharge it from the pores. This cleaning effect is also achievable for HNO₃, as well as for diverse other solvents that are not well tolerated by the organism, which are thus able to be reliably removed from the smallest pores by the procedure provided according to the present invention.

CO₂ converted to a supercritical state (SCCO₂) is particularly well suited for dissolving nonpolar molecules. Thus, by inputting and exchanging SCCO₂ in the pore volumes, one is able to discharge all residues or pollutions from them. In order also to be able to dissolve residues and pollutants in the form of polar substances from the surfaces of the nanoscale pores or discharge them from their volumes, an auxiliary solvent, especially a surfactant, may be added to the substance that is to be converted to the supercritical state, so that an appropriate microemulsion is produced. Mycelia form in the process, which enclose the polar substance within them. In this connection, the polar ends of the surfactants point inwards and the nonpolar ones point outwards, so that even polar substances may be dissolved using the SCCO₂ and removed from the porous material. This is able to guarantee the required cleanliness or hygiene, for the use of such substrates having nanoscale pores, in the medical field, particularly in contact with living cells.

The substances that are dissolved out, that is, contaminants or residues, are conveyed out of a process chamber when one is carrying out the method, and when the medium is expanded into the gaseous state, it is precipitated and absorbed using appropriate means, such as filters or active charcoal. In this way, the residues dissolved out from the pores are able to be reliably removed from the process.

In order to improve the storage properties of the cleaned nanoscale pores, particularly with regard to the accommodation of active substances for medicinal applications, the substrate may further have applied to it, for instance, a substance modifying the surface properties of the nanoscale pores and/or an appropriate processing method. For this, the application of O₂ plasma is particularly suitable to generate hydroxyl groups on a silicon surface, in order to produce quite a special reaction with the pore surface that is adjusted to the substance that is to be introduced into the substrate. In this connection, a silicon surface is frequently involved, since this biocompatible material is either encapsulated harmlessly in the body after its penetration, being able also to be removed later if necessary, or it is broken down to harmless silicic acid which is present in the body anyway.

For the storage or deposition of active substances, especially medicinally active substances in such nanoscale pores, it is furthermore provided that this active substance be admixed to the substance or substance mixture that is to be converted to the supercritical state. By doing that, the advantageous properties, namely, the penetration into the smallest recess and possibly the transport of an additional substance or mixture of substances, of the substance or mixture of substances that is in the supercritical state, may also be utilized for filling up these storage volumes. For this, too, SCCO₂ is provided in an especially preferred manner, because of its effectiveness as being nontoxic and as being highly dissolving with respect to nonpolar substances. After the penetration of this carrier medium into the pores, the active substances taken up into it may be stored therein, for instance, by adsorption to the inner pore surfaces.

For the introduction of polar substances into the nanoscale pores, the admixture of a surfactant to the substance reduced in its surface tension is again preferably provided, according to the cleaning process described above. With that provision, polar substances are now able to be introduced, in the opposite transporting direction, from the outside to the inside of the nanoscale pores, and be connected in a depositing manner, possibly by a chemical and/or physical reaction, to the surface of the pore. Using the treatment method described above, pore surfaces that have had O₂ plasma applied to them are particularly suitable for such types of storage.

A further possibility for depositing active substances on the inside of nanoscale pores is able to be implemented by influencing the density of the substance or mixture of substances that are in the supercritical state. To do this, one may act directly on the mass transport or the dissolving capability of the SCCO₂ by varying the pressure. This means that first, under a sufficiently high pressure, the substance to be introduced is dissolved in the SCCO₂ and, after time-wise sufficiently long application, is transported into the deepest locations of the porous structure. After the expiration of the time provided for this process, the density of the CO₂ is decreased by reducing the pressure in such a way that, because of the reduced dissolving capability caused thereby, the active substance to be stored precipitates from the CO₂ and deposits on the inside of the nanoscale structures. A further possibility of exerting influence on the density of the SCCO₂ is by varying its temperature.

To carry out these methods, furthermore, a device is provided for treating such a material that has nanoscale pores, especially for implant material for the treatment of living cells. This device stands out especially in that it has means for reducing the surface tension of a substance or a corresponding mixture of substances provided for filling the volume of the nanoscale pores. In particular, such means may include a device that increases and/or decreases the average prevailing pressure, such as a high-pressure pump, a compressor or the like. Means for exerting an influence on the temperature of a substance, or mixture of substances, that is to be converted to a supercritical state, are also suitable, for instance, an electrical heating device.

Moreover, this device may advantageously include appropriate retention means or filtering means for accommodating discharged pollutants, if necessary in combination with means changing the pressure and/or temperature. Because of this, residues or impurities removed from the pores by separating out from the substrate may be harmlessly collected locally.

In a further advantageous manner, the device may also be provided with means for introducing a surfactant into the device. For instance, an appropriate storage device may be involved in this case, a valve and/or a pressure control device, a metering device and, if necessary, additional control and/or regulating units. Of course, such storage devices and/or pressure control means may also be provided for the substance whose surface tension is being reduced.

### A BRIEF DESCRIPTION OF THE SEVERAL VIEWS OF THE DRAWING

FIG. 1 is a flow chart showing symbolically individual steps of a method for treating material having nanoscale pores.

FIG. 2 shows a schematic top view of a material having nanoscale pores.

FIG. 3 shows an enlarged representation of a sectional view from FIG. 2.

FIG. 4 shows a schematic representation of a device suitable for carrying out the method.

### DETAILED DESCRIPTION OF THE INVENTION

Flow chart 1 shows symbolically individual method steps 2 to 5 for carrying out a method for treating material having nanoscale pores, especially of implant material for treating living cells. Arrows 6 symbolize the transitions between individual method steps 2 to 5. Arrow 7 symbolizes a repetition of method step 5 if this is necessary.

In method step 2 the surface tension of a substance 10 or a mixture of substances 10 is reduced, that are provided for filling the volumes of nanoscale pores 9 of a material 8 (FIGS. 2, 3). In this context, the surface tension is so greatly reduced that substance 10 is able to penetrate completely into nanoscale pores 9. The substance or the mixture of substances 10 is converted to a supercritical state for this purpose. It is particularly preferred to use CO₂ for this, which, on the one hand, has no toxic effect on living cells and, on the other hand, has very good dissolving properties with respect to residues or contaminations that are to be removed from the nanoscale pores, which may originate, for instance, from the production process. In this connection, deposition residues from anodizing methods for producing nanostructured pores have to be removed, such as hydrofluoric acid (HF) or HNO₃, or other diverse solvents and the like which are not well tolerated by the organism.

After penetrating the nanoscale pores, the CO₂ (SCCO₂), that has been put into the supercritical state, is able to act as a solvent and dissolve the residues located in them, and, based on its comparatively negligible surface tension, remove them from the surface of the pores, leaving it free of residue, and subsequently discharge them from the pores, also leaving them free of residues. FIG. 3, which is shown as an enlargement of a section from FIG. 2, illustrates this procedure. On the inside of the enlarged view shown as a sectional representation, there is adhering a residue 11 or a contamination 11, which originate, for example, from the production process of nanoscale pore 9. Now, substance 10, which is in the supercritical state, e.g., SCCO₂, has such a reduced surface tension that it is able to penetrate without a problem into the inside of this pore, dissolve the contamination present in it and, as a result, discharge it from pore 9.

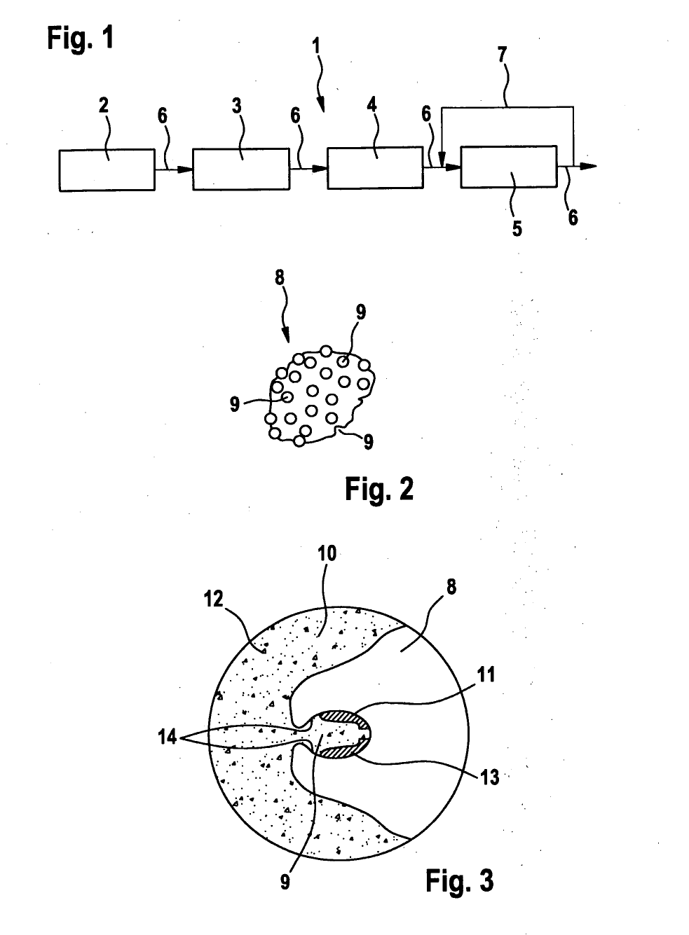

To improve the cleaning effect, or rather, to bind possibly present polar residues, according to method step 3 in FIG. 1, an auxiliary solvent, particularly a surfactant, may be admixed to the substance that is to be converted to a supercritical state. This binds polar residues in such a way that their polar side points inwards and their nonpolar side points outwards, whereby again a residue-free removal is made possible from the nanoscale pore.

Subsequently, and again optionally, a method step 4 as in FIG. 1 may be carried out. In this context, for example, in order to modify the surface properties of nanoscale pores 9, material 8 provided as the carrier material for active substances is able to have applied to it O₂ plasma for generating hydroxyl groups, for instance, on a silicon surface. This makes it possible to make a quite definite adjustment to individual substances, that are to be introduced, with respect to a reaction between these substances and the pore surface.

Next, method step 5 according to FIG. 1 is carried out, in which the substance or mixture of substances 10, functioning as the carrier medium, that is to be put into the supercritical state, has admixed to it an active substance 13 that is to be stored in nanoscale pores 9. In order to deposit substance 13 that is to be stored, a chemical and/or physical reaction may be triggered between substance 13 that is to be stored and surface 14 of nanoscale pores 9.

In order to deposit substance 13 that is to be stored in nanoscale pores 9, the density of substance 10, that is in the supercritical state, may be reduced, after the expiration of an appropriate transportation time for introducing the active substance into the pores. By doing this, active substance 13, that is bound in carrier medium 10 on the inside of pores 9, precipitates and is able to be adsorbed on pore wall 14, for example. If necessary, this method step 5 may be carried out repeatedly so as to increase the storage density on the inside of the pores.

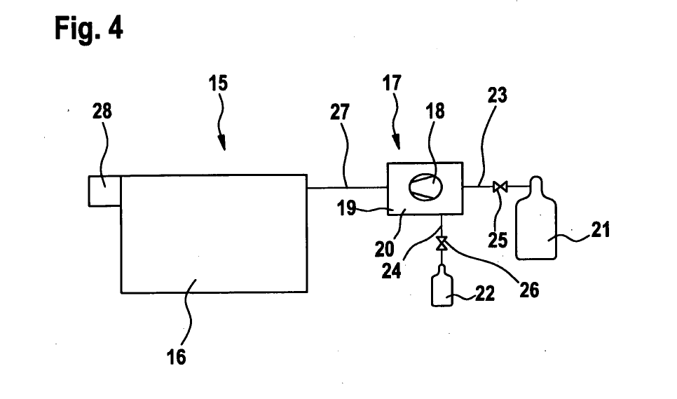

A device 15 for carrying out these method steps is shown schematically in FIG. 4, as an example embodiment. Besides a pressure chamber 16 for accommodating material 8 having nanoscale pores 9, it includes means 17 for reducing the surface tension of substance 10 that is provided to fill the volumes of nanoscale pores 9.

These means 17 may include, among other things, a high-pressure pump 18, a heating device 19, and additional control and/or regulating units 20, if necessary.

A CO₂ storage unit 21 and a storage unit 22, having material 13 that is to be deposited, are also shown, for the sake of completeness. They are connected to unit 17 by pipes 23, 24 as well as valves 25 and 26. Unit 17, on its part, is connected to chamber 16 via pipe 27. The monitoring of the entire equipment may be performed by control unit 28, for instance.

Pressure chamber 16 may also include a heating unit 19 and additional control and/or regulating units 20. As a rule, auxiliary solvents (co-solvents) are added to increase the solubility of active substance 13 in carrier medium 10.

1-13. (canceled)

14. A method for treating a host material having nanoscale pores, comprising:
providing an implant material configured to fill the nanoscale pores; and
reducing a surface tension of the implant material prior to introduction into the nanoscale pores.

15. The method as recited in claim 14, wherein the host material a living cell, and wherein, for the reduction of the surface tension, the implant material is converted to a supercritical state prior to the introduction into the nanoscale pores.

16. The method as recited in claim 15, wherein the implant material converted to a supercritical state is CO₂.

17. The method as recited in claim 15, wherein the implant material converted into the supercritical state is introduced into the nanoscale pores to discharge one of contaminations or residues located in the nanoscale pores.

18. The method as recited in claim 15, wherein the implant material converted into the supercritical state is introduced into the nanoscale pores to dissolve one of contaminations or residues adhering to the surfaces of the nanoscale pores.

19. The method as recited in claim 15, further comprising:
admixing an auxiliary solvent to the implant material.

20. The method as recited in claim 15, further comprising:
applying a modifying substance to the host material having the nanoscale pores, wherein the modifying substance is configured to modify the surface properties of the nanoscale pores.

21. The method as recited in claim 15, further comprising:
admixing an active substance to the implant material, wherein the active substance is configured to be stored in the nanoscale pores.

22. The method as recited in claim 21, wherein, in order to deposit the active substance in the nanoscale pores, at least one of a chemical reaction and a physical reaction is triggered between the active substance and the surface of the nanoscale pores.

23. The method as recited in claim 21, wherein, for the deposition of the active substance in the nanoscale pores, the density of the implant material in the supercritical state is changed.

24. A device for applying an implant material to a host material having nanoscale pores, comprising:
an arrangement configured to reduce the surface tension of the implant material provided for filling the nanoscale pores of the host material.

25. The device as recited in claim 24, wherein the arrangement configured to reduce the surface tension includes a device configured to selectively vary a prevailing pressure in the arrangement.

26. The device as recited in claim 25, wherein the arrangement configured to reduce the surface tension includes a device configured to selectively vary a prevailing temperature in the arrangement.
